(19) United States
(12) Patent Application Publication
(10) Pub. No.: US 2007/0097678 A1
(43) Pub. Date: May 3, 2007

(54) Bulb with light emitting diodes

(76) Inventor: Sheng-Li Yang, Hsinchu City (TW)

Correspondence Address: BACON & THOMAS, PLLC, 625 SLATERS LANE, FOURTH FLOOR, ALEXANDRIA, VA, 22314, US

(21) Appl. No.: 11/262,789

(22) Filed: Nov. 1, 2005

(51) Int. Cl. B60Q 1/26

(52) U.S. Cl. 362/227; 362/249; 362/252

(57) ABSTRACT

A bulb includes a top light-emitting module having a top circuit board and light emitting diodes (LEDs). The top circuit board has first lock slots and wires electrically connected to the LEDs respectively. Vertical light-emitting modules have a vertical circuit board with a first coupling portion and a second coupling portion and LEDs respectively. The first coupling portions are inserted into the first lock slots of the top light-emitting module. A positioning base has a positioning plate and a coupling portion. The positioning plate has second lock slots to engage the second coupling portions respectively. The positioning base has a through hole through the positioning plate and the coupling portion for the wires passing through. A cap is fixed to the coupling portion of the positioning base, and the wires through the through hole are electrically connected to a bottom of the cap.

### BACKGROUND OF THE INVENTION

1. Field of the Invention

The present invention relates generally to a LED lamp, and more particularly to a bulb with light emitting diodes (LEDs).

2. Description of the Related Art

As the improvement of technique, there are high-luminance light emitting diodes (LED) in the present market, and such LEDs are broadly applied to various products, such as interior lights and taillight of automobile.

LED has to be connected to the socket for LED only, and it can't be connected to the socket for tungsten lamp directly. Therefore, while user wants to replace tungsten lamp with LED, both of the lamp and the socket have to be replace together. It raises the cost for replacement. Some improved LED is provided, which can be connected to the socket for tungsten lamp directly, such that it can reduce the cost to replace tungsten lamp with LED. Such new LED bulb has vertical plates, on which LEDs are provided, with two ends inserted into a top plate and a bottom plate respectively, and the bottom plate is connected to a conventional cap. Therefore, the vertical plates have to be inserted into the bottom plate and connect wires to the cap. This process is difficult and has higher cost, so that the LED bulbs can't be provided to consumers with lower price.

### SUMMARY OF THE INVENTION

The primary objective of the present invention is to provide a LED bulb with a simple assembling process.

According to the objective of the present invention, a bulb type light emitting diode structure comprises a top light-emitting module having a top circuit board and a plurality of light emitting diodes. The top circuit board has a plurality of first lock slots thereon and wires electrically connected to the light emitting diodes respectively. A plurality of vertical light-emitting modules have a vertical circuit board and a plurality of light emitting diodes respectively. Each of the vertical circuit boards has a first coupling portion and a second coupling portion on two ends thereof respectively. The first coupling portions are inserted into the first lock slots of the top light-emitting module respectively to electrically connect the vertical light-emitting modules to the top light-emitting module. A positioning base has a positioning plate and a coupling portion projected from a side of the positioning plate. The positioning plate has a plurality of second lock slots at a side opposite to the coupling portion to engage the second coupling portions of the vertical light-emitting modules respectively. The positioning base has a through hole through the positioning plate and the coupling portion for the wires passing through. A cap has a top fixed to the coupling portion of the positioning base. The wires through the through hole are electrically connected to a bottom of the cap.

### BRIEF DESCRIPTION OF THE DRAWINGS

FIG. 1 is an exploded view of a first preferred embodiment of the present invention;

FIG. 2 is a sectional view of the first preferred embodiment of the present invention; and

FIG. 3 is a sectional view of a second preferred embodiment of the present invention.

### DETAILED DESCRIPTION OF THE INVENTION

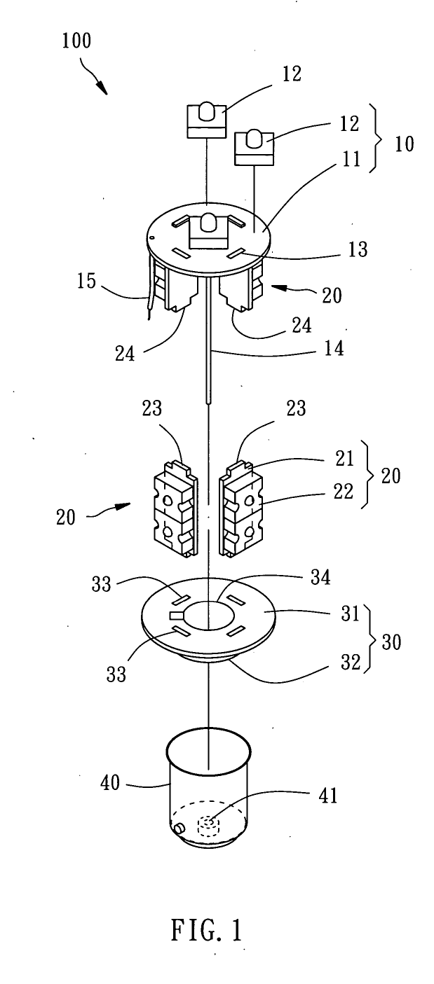

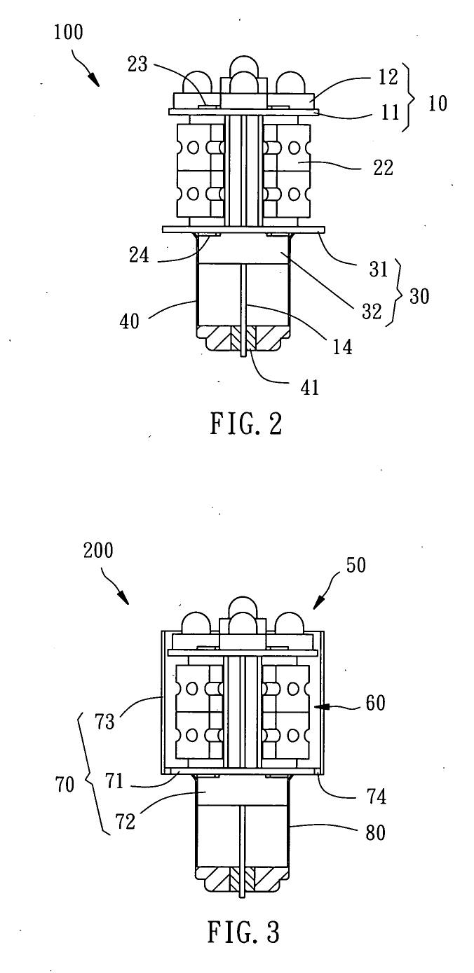

As shown in FIGS. 1 to 2, a bulb with light emitting diodes (LEDs) 100 of the first preferred embodiment of the present invention mainly comprises a top light-emitting module 10, a plurality of vertical light-emitting modules 20, a positioning base 30, and a cap 40.

The top light-emitting module 10 has a top circuit board 11 and a plurality of light emitting diodes (LEDs) 12. The top circuit board 11 substantially is a disk-like member having a predetermined conductor pattern (not shown) and a plurality of first lock slots 13 with a predetermined interval therebetween. There is a predetermined interval between the neighboring first slots 13. The LEDs 12 are connected to a top side of the top circuit board 11 and electrically connected to the conductor pattern. The top circuit board 11 is provided with wires 14 and a ground wire 15 on a bottom side thereof.

Each of the vertical light-emitting modules 20 has a vertical circuit board 21 and a plurality of LEDs 11. The vertical circuit board 21 substantially is a rectangular member having a predetermined conductor pattern (not shown) and a first coupling portion 23 and a second coupling portion 24 on ends thereof respectively. The LEDs 22 are connected to a top side of the vertical circuit board 21 and electrically connected to the conductor pattern.

The positioning base 30 has a positioning plate 31 and a coupling portion 32. The positioning plate 31 is a disk-like member having a plurality of second lock slots 33 with a predetermined interval therebetween. The coupling portion 32 is projected from the positioning plate 31 at a side opposite to the second lock slots 33 with a diameter are less than that of the positioning plate 31. The positioning plate 31 has a through hole 34 through the coupling portion 32.

The cap 40 is as same as the conventional bulb cap to be connected to a conventional bulb socket, which is hollow and coated with insulating coating on an interior side. The cap 40 has a bottom with a convex conductive connector 41.

Above are the elements of the bulb type LED structure 100, and we are going to describe the assembling and characters hereunder.

First, the vertical light-emitting modules 20 have the first coupling portions 23 inserted into the first lock slots 13 of the top light-emitting module 10. With the touch of the first lock slots 13 and the first coupling portions 23, the vertical light-emitting modules 20 are electrically connected to the top light-emitting module 10. And then, the second coupling portions 24 of the vertical light-emitting modules 20 is inserted into the second lock slots 33 of the positioning base 30 to draw the wires 14 and the ground wire 15 out via the through hole 34 of the positioning base 30. As a result, the top light-emitting module 10, the vertical light-emitting modules 20, and the positioning base 30 is connected together with a fixed relative relationship. The ground wire 15 is fixed to the cap 40 by welding, and then the cap 40 is fitted to the coupling portion 32 of the positioning base 30 with the wires 14 connected to the conductive connector 41 of the cap 40 (it is done by welding too). The assembling process of the present invention is completed.

The present invention has a specific structure and the corresponding assembling process that make the assembling process easier. While the positioning base is engaged with the vertical light-emitting modules, the wires and the ground wire are exposed to facilitate the welding of the wires and the ground wires with the cap.

As shown in FIG. 3, a LED bulb 200 of the second preferred embodiment of the present invention includes a top light-emitting module 50, a plurality of vertical light-emitting modules 60, a positioning base 70, and a cap 80. Theses elements are as same as the elements above, and the differences of the second preferred embodiment are hereunder.

The positioning base 70 has a positioning plate 71 and a coupling portion 72 projected from a bottom side of the positioning plate 71 also. The positioning plate 71 is provided with a transparent shell member 73 with bores 74.

After assembling process of the LED structure 200, the shell member 73 covers the vertical light-emitting modules 60 and is connected to a margin of the top light-emitting module 50. The shell member 73 protects the vertical light-emitting modules 60 from impact, and the bores 74 of the shell member 73 can prevent the vertical light-emitting modules 60 from overheat.

What is claimed is:

1. A bulb, comprising:
a top light-emitting module having a top circuit board and a plurality of light emitting diodes, wherein the top circuit board has a plurality of first lock slots thereon and wires electrically connected to the light emitting diodes respectively;
a plurality of vertical light-emitting modules, each of which has a vertical circuit board and a plurality of light emitting diodes, wherein each of the vertical circuit boards has a first coupling portion and a second coupling portion on two ends thereof respectively, and the first coupling portions are inserted into the first lock slots of the top light-emitting module respectively to electrically connect the vertical light-emitting modules to the top light-emitting module;
a positioning base having a positioning plate and a coupling portion projected from a side of the positioning plate, wherein the positioning plate has a plurality of second lock slots at a side opposite to the coupling portion to engage the second coupling portions of the vertical light-emitting modules respectively, and the positioning base has a through hole through the positioning plate and the coupling portion for the wires passing through;
a cap having a top fixed to the coupling portion of the positioning base, wherein the wires through the through hole are electrically connected to a bottom of the cap.

2. The bulb as defined in claim 1, wherein the top circuit board has a conductor pattern, on which the light emitting diodes are electrically connected.

3. The bulb as defined in claim 1, wherein the vertical circuit board has a conductor pattern, on which the light emitting diodes are electrically connected.

4. The bulb as defined in claim 1, wherein the cap is as same as a conventional bulb cap to be connected to a conventional bulb socket.

5. The bulb as defined in claim 1, wherein the top circuit board has a ground wire, and the cap is coated with an insulating coating on an interior side thereof, such that the ground wire runs through the through hole of the positioning base and is electrically connected to the cap.

6. The bulb as defined in claim 1, wherein the cap has a convex conductive connector at the bottom, on which the wires are connected.

7. The bulb as defined in claim 1, wherein the positioning base further has a transparent shell member projected from the positioning plate to cover the vertical light-emitting modules and to rest a free end thereof on a margin of the top circuit board.

8. The bulb as defined in claim 7, wherein the shell member has bores.
